(19) United States
(12) Patent Application Publication
(10) Pub. No.: US 2016/0109968 A1
(43) Pub. Date: Apr. 21, 2016

(54) METHOD FOR EXECUTING FUNCTION AND ELECTRONIC DEVICE IMPLEMENTING THE SAME

(71) Applicant: Samsung Electronics Co., Ltd., Gyeonggi-do (KR)

(72) Inventors: Hohyun ROH, Gyeongsangbuk-do (KR); Jiwoo Lee, Gyeongsangbuk-do (KR)

(73) Assignee: Samsung Electronics Co., Ltd.

(21) Appl. No.: 14/919,262

(22) Filed: Oct. 21, 2015

(30) Foreign Application Priority Data
Oct. 21, 2014 (KR) 10-2014-0142888

(51) Int. Cl. G06F 3/0354; G06F 3/038; G06F 3/0482; G06F 3/046; G06F 3/0484

(52) U.S. Cl. CPC G06F 3/03545; G06F 3/046; G06F 3/04842; G06F 3/0482; G06F 3/0383

(57) ABSTRACT

Disclosed are a method and electronic device for executing a function. The method includes detecting a removal of an electronic pen from the electronic device by using a plurality of detection sensors, determining a time interval based on a first time of an inactivity release signal detected by a first detection sensor among the plurality of detection sensors, or a second time of the inactivity release signal detected by a second detection sensor among the plurality of detection sensors corresponding to the removal of the electronic pen, and executing at least one function related to a script input using the electronic pen if the time interval is less than a critical value.

### PRIORITY

This application claims priority under 35 U.S.C. §119(a) to Korean Patent Application No. 10-2014-0142888, filed in the Korean Intellectual Property Office on Oct. 21, 2014, the contents of which are incorporated herein by reference.

### BACKGROUND OF THE INVENTION

1. Field of the Invention

The present invention relates generally to a method for executing a function, and more particularly, to a method and electronic device for executing a function by using a pen type input device, such as a stylus pen and a touch pen, installed in the electronic device.

2. Description of the Related Art

Various portable electronic devices that provide user convenience through various functions and designs have been recently introduced. For example, the portable electronic device provides basic telephone functions as well as Internet, image recording, and multimedia file play functions. The portable electronic device further provides a touch input device such as a display unit including a touch panel as well as various input devices such as a touch pen, stylus pen, and electronic pen for precise user input. The pen type input device can be stored in the portable electronic device for convenience and portability.

When a pen installed in an electronic device is removed from the electronic device, the electronic device provides an interface for some applications to be selected from a plurality of installed applications based on a pen operation. However, when executing a predetermined interface based on the attaching and detaching of a pen, the conventional electronic device provides a predetermined interface regardless of a user's intention. Therefore, a problem arises in that an additional user operation is required to select a desired function.

### SUMMARY OF THE INVENTION

The present invention has been made to address the above-mentioned problems and disadvantages, and to provide at least the advantages described below.

Accordingly, an aspect of the present invention is to provide a method for identifying a pen removal of the electronic pen through a sensor unit including a plurality of sensors, identifying a user's intention of using a pen by using a time interval measured by each sensor, and executing a corresponding function, and an electronic device implementing the same.

According to an aspect of the present invention, a method for executing a function includes detecting a removal of an electronic pen from the electronic device by using a plurality of detection sensors, determining a time interval based on a first time of an inactivity release signal detected by a first detection sensor among the plurality of detection sensors, or a second time of the inactivity release signal detected by a second detection sensor among the plurality of detection sensors corresponding to the removal of the electronic pen, and executing at least one function related to a script input using the electronic pen if the time interval is less than a critical value.

According to another aspect of the present invention, an electronic device for executing a function includes a sensor unit configured to include a plurality of detection sensors and to measure a time interval required for removing an electronic pen from the electronic device based on the plurality of detection sensors, and a control unit configured to detect removal of the electronic pen from the electronic device through the sensor unit, to determine a time interval based on a first time of an inactivity release signal detected by a first detection sensor among the plurality of detection sensors, or a second time of an inactivity release signal detected by a second detection sensor among the plurality of detection sensors corresponding to the removal of the electronic pen from the electronic device, and to execute at least one function related to a script input using the electronic pen if the time interval is less than a critical value.

### BRIEF DESCRIPTION OF THE DRAWINGS

The above and other aspects, features, and advantages of embodiments of the present invention will be more apparent from the following description taken in conjunction with the accompanying drawings, in which:

FIG. 1 illustrates a configuration of an electronic device according to various embodiments of the present invention;

FIG. 2 illustrates components of an electronic device according to various embodiments of the present invention;

FIG. 3 illustrates a method for executing a function corresponding to a time required for removing a pen according to various embodiments of the present invention;

FIG. 4 illustrates a method for executing a function corresponding to a time required for removing a pen according to an embodiment of the present invention;

FIGS. 5A, 5B, 5C and 5D illustrate a method for executing a function according to an embodiment of the present invention;

FIG. 6 illustrates a method for executing a function corresponding to a time required for removing a pen according to another embodiment of the present invention;

FIGS. 7A, 7B, 7C and 7D illustrate the method for executing a function described in FIG. 6;

FIG. 8 illustrates a method for executing a function corresponding to a time required for removing a pen according to an embodiment of the present invention; and

FIGS. 9A, 9B, and 9C illustrate the method for executing a function described in FIG. 8.

### DETAILED DESCRIPTION OF EMBODIMENTS OF THE INVENTION

Embodiments of the present invention are described in detail with reference to the accompanying drawings. Various changes may be made, and the disclosure may have various forms, but the present invention is not limited thereto and it should be understood that the embodiments herein include all changes, equivalents, and substitutes within the spirit and scope of the disclosure. Throughout the drawings, like reference numerals refer to like components. A detailed description of known functions and configurations will be omitted, for the sake of clarity and conciseness.

It will be understood that the expressions “comprises” and “may comprise” are used to specify presence of disclosed functions, operations, and components, but do not preclude the presence of one or more functions, operations, and components. It will be further understood that the terms “comprises” and/or “has” when used in this specification, specify the presence of stated features, numbers, steps, operations, components, elements, or a combination thereof but do not preclude the presence or addition of one or more other features, numbers, steps, operations, components, elements, or combinations thereof. In the present invention, the expression “and/or” is taken as specific disclosure of each and any combination of enumerated things. For example, A and/or B is to be taken as specific disclosure of each of A, B, and A and B.

As used herein, terms such as “first” and “second” are used to describe various components, but it is obvious that the components should not be defined by these terms. For example, the terms do not restrict the order and/or importance of the corresponding components. The terms are used only for distinguishing one component from another component. For example, a first component may be referred to as a second component and likewise, a second component may be referred to as a first component, without departing from the teaching of the inventive concept.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

An expression “detachment of pen” used in various embodiments of the present invention includes removing or separating a pen installed in an electronic device. An expression “insertion of pen” includes inserting or attaching the pen into the electronic device. The expressions “detachment of pen” or “insertion of pen” should be understood as attaching or detaching a pen to/from an electronic device.

The pen used in various embodiments of the present invention enables an input in a display unit, such as a touch screen of the electronic device, which may be a stylus pen. The pen disclosed in the present invention should be understood as an input device that can be attached or detached to/from an electronic device and can generate a touch input in a touch screen.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

According to various embodiments of the present invention, the electronic device includes devices having an operation support function such as a smartphone, table personal computer (PC), mobile phone, video phone, electronic book (e-book) reader, desktop PC, laptop PC, netbook computer, personal digital assistant (PDA), portable multimedia player (PMP), MP3 player, mobile medical appliance, camera, and a wearable device such as a head-mounted device (HMD) including electronic glasses, electronic clothing, electronic bracelet, electronic necklace, electronic appcessory, electronic tattoo, and a smartwatch.

According to an embodiment, the electronic device may be one of smart home appliances having operation support function, including a television (TV), digital video disk (DVD) player, audio player, refrigerator, air-conditioner, vacuum cleaner, electronic oven, microwave oven, laundry machine, air cleaner, set-to box, TV box such as Samsung HomeSync™, Apple TV™, and Google TV™, game console, electronic dictionary, electronic key, camcorder, and electronic frame.

According to an embodiment, examples of the electronic device include medical devices such as magnetic resonance angiography (MRA), magnetic resonance imaging (MRI), and computed tomography (CT) devices, a navigation device, global positioning system (GPS) receiver, event data recorder (EDR), flight data recorder (FDR), car infotainment device, maritime electronic device such as a maritime navigation device and gyro compass, aviation electronic device, security device, vehicle head unit, industrial or home robot, automatic teller's machine (ATM) of a financial institution, and point of sales (POS) device.

According to an embodiment, examples of the electronic device include furniture and building/structure having a communication function, electronic board, electronic signature receiving device, projector, and metering device such as water, electric, gas, and electric wave metering devices. According to various embodiments, the electronic device may be any combination of the aforementioned devices and may be a flexible device. It is obvious to those skilled in the art that the electronic device is not limited to the aforementioned devices.

The term ‘user’ used in various embodiments may denote a person or a device such as an artificial intelligence electronic device using the electronic device.

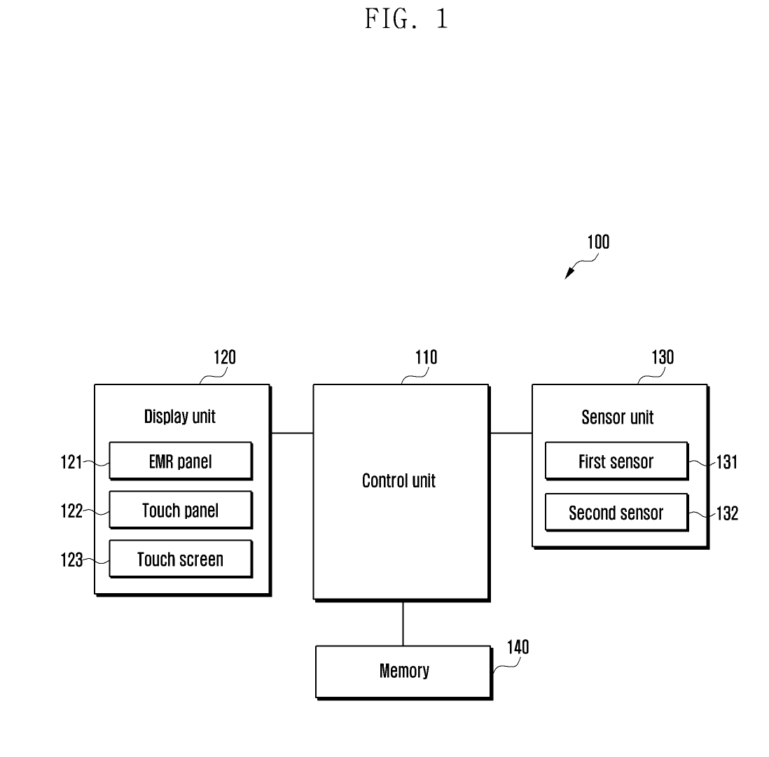

FIG. 1 illustrates a network environment including electronic devices according to embodiments of the present invention. Referring to FIG. 1, the electronic device 101 includes a control unit 110, a display 120, a sensor unit 130, and a memory 140.

The bus connects the aforementioned components to each other and is a circuit for exchanging signals such as control messages among the components.

The control unit 110 controls general operations of the electronic device 100. For example, the control unit 110 receives a command from other components such as the display unit 120, sensor unit 130, and memory 140 through the bus, interprets the command, and calculates or processes data according to the interpreted command. The control unit 110 determines a pen insertion through the sensor unit 130, and measures a time required for removing the pen if the inserted pen is removed. The control unit 110 compares the time required for removing a pen with a critical value stored in the memory 140, and executes a predetermined function according to the comparing result. The predetermined function may be an application or program stored in the memory 140, and may be displayed through the display unit 120.

The display unit 120 displays a variety of information stored in the memory 140. The display unit 120 includes a panel and a control circuit for controlling the panel, such as an electro-magnetic resonance (EMR) panel 121 that determines an electromagnetic resonant signal through a coil having a resonant frequency. An EMR method using the EMR panel 121 distinguishes a finger input and a stylus pen input with a separately integrated digitizer, and the EMR panel 121 may be configured with a small stylus that distinguishes a plurality of touch pressure steps.

The display unit 120 includes a touch panel 122, and an electrostatic type touch panel 122 determines a pen tip having a dielectric property. The display unit 120 includes a touch screen 123 together with the EMR panel 121 and the touch panel 122. The touch screen 123 displays a specific image and receives a user input by including in the display unit 120 of the electronic device 100. The display unit 120 includes an EMR panel 121, touch panel 122, and touch screen 123, which may be used as an input device as well as an output device for displaying a variety of information.

The EMR panel 121 utilizes an EMR method, and distinguishes a user's finger input and an electronic pen input. The electronic pen integrates an EMR coil that is distinguished from general touch pens. The EMR panel 121 can also distinguish touch pressures input by using an electronic pen. The EMR panel 121 more delicately and precisely recognizes an input of the electronic pen in comparison to that of conventional touch pens.

The sensor unit 130 measures a physical quantity or detects an operating state of the electronic device 100, and converts the measured or detected information to an electric signal. The sensor unit 130 according to various embodiments of the present invention detects insertion and removal of a pen in the electronic device 100 by using at least 2 sensors such as the first sensor 131 and second sensor 132.

The first sensor 131 and the second sensor 132 detect insertion and removal of a pen by integration in the electronic device 100. For example, the first sensor 131 and the second sensor 132 are switch sensors that are switched off by pressing a switch, and if the pen is removed, the first sensor 131 and the second sensor 132 are switched on by releasing the switch. The switching on/off becomes a basis for identifying the insertion and removal of a pen. However, the present invention is not limited to switching off the sensors when the switch is pressed. For example, the sensors can be switched on when the pen is inserted and the switch is pressed, in which case the first sensor 131 and the second sensor 132 may be formed with switch sensors having a swing mechanism.

Alternatively, the first sensor 131 and the second sensor 132 may be Hall sensors that differentiate a voltage according to a magnetic field intensity, and detect a change of the magnetic field intensity through a Hall Effect. The Hall effect is a phenomenon that generates a voltage change (i.e., electric field) perpendicular to a direction of an electric current flowing through a conductor, if a magnetic field is formed perpendicular to the direction of a current flowing through the conductor. The Hall sensor detects a magnetic field of a magnet installed in a pen based on the Hall Effect. The magnet is installed in the pen corresponding to the location of the Hall sensor in of the pen insertion state. If a magnetic field having a specific intensity is detected from a plurality of Hall sensors, the control unit 110 determines insertion of a pen. The first sensor 131 and the second sensor 132 detect a magnetic field of a magnet installed in the pen by using a Hall sensor, and transmit a signal of the magnetic field to the control unit 110 which determines insertion and removal of a pen based on the received signal.

Alternatively, the first sensor 131 and the second sensor 132 may be configured with EMR sensors that detect a resonant frequency emitted from a coil installed in the pen. The EMR sensor is installed in the electronic device 100, and detects a resonant frequency from a coil installed in the pen. For example, the coil emitting a resonant frequency is installed in an upper part of the pen, such as the pen tip or pen head, and a lower part such as the tail of the pen. The coils installed in the upper and lower parts of the pen may have different winding numbers, winding intervals, and winding cross sections so that the coils can emit different resonant frequencies in comparison to each other. The winding number indicates the number of windings of an electric wire. The resonant frequencies emitted from the upper and lower parts of the pen are differentiated so as to measure a time required for removing the pen.

For example, the EMR sensor is installed in the electronic device 100 corresponding to the location of the coil installed in the lower part of the pen. When the pen is inserted in the electronic device 100, the EMR sensor receives a resonant frequency emitted from the coil installed in the lower part of the pen. If the pen is removed from the electronic device 100, the EMR sensor receives a resonant frequency emitted from the upper part of the pen. The EMR sensor detects resonant frequencies differently emitted by the upper and lower parts of the pen, and transmits the resonant frequencies to the control unit 110, which thereby identifies insertion of the pen through the EMR sensor.

The memory 140 receives and stores commands or data generated by the control unit 110 or other components such as the sensor unit 120 and display unit 130. The memory 140 includes an internal memory or an external memory. For example, the internal memory includes at least one of a volatile memory such as a dynamic random access memory (DRAM), static RAM (SRAM), and synchronous dynamic RAM (SDRAM), or a non-volatile memory such as one time programmable read-only memory (OTPROM), PROM, erasable and programmable ROM (EPROM), electrically erasable and programmable ROM (EEPROM), mask ROM, flash ROM, NAND flash memory, and NOR flash memory. The internal memory may be a solid state drive (SSD) and may further include a flash drive such as a compact flash (CF), secure digital (SD), Micro-SD, Mini-SD, extreme digital (xD), and memory stick. The external memory is functionally connected with the electronic device 100 through various interfaces, and the electronic device 100 further includes a storage device such as a hard disk drive.

The memory 140 according to various embodiments of the present invention stores a variety of information for identifying insertion of a pen by receiving the information from the first sensor 131 and the second sensor 132 of the sensor unit 130. The memory 140 further stores a time required for removing a pen and a critical value. The critical value for comparing with the time required for removing a pen is predetermined by a developer or a user, and is determined based on the time required for removing the pen. The memory 140 stores a programming module for executing a specific function according to the comparing result of the time required for removing a pen and the critical value. The specific function is a specific application predetermined by a developer or a user.

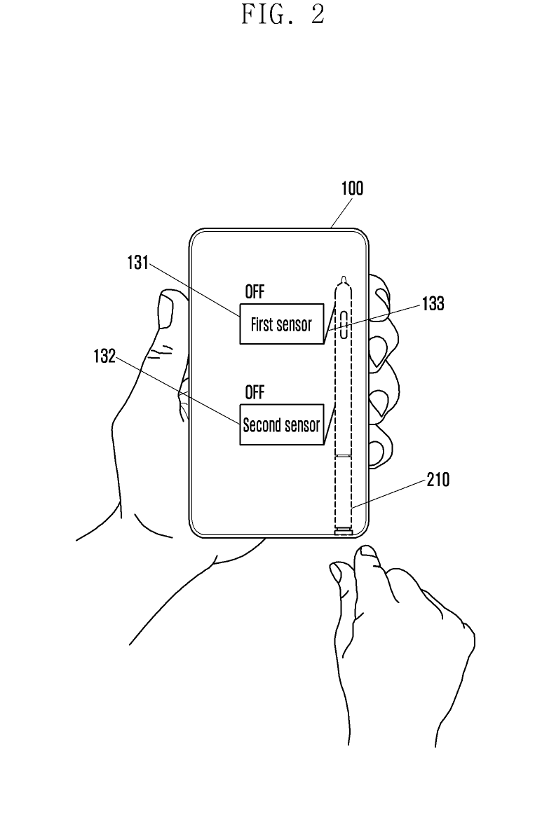

FIG. 2 illustrates components of an electronic device according to various embodiments of the present invention

Referring to FIG. 2, the electronic device 100 integrates the first sensor 131 and the second sensor 132, and a pen 210 is inserted in the electronic device 100. When the pen 210 is inserted, both the first sensor 131 and the second sensor 132 are in a switched-off state, which indicates that a sensor is in an inactive state. For example, if the pen 210 is inserted in the electronic device 100, the first sensor 131 and the second sensor 132 are in an inactive state. If the pen 210 is removed from the electronic device 100, the first sensor 131 and the second sensor 132 sequentially change from an inactive state to an active state. The first sensor 131 and the second sensor 132 are configured with switch sensors, and are placed in a switched-off state by pressing a switch 133 as shown in FIG. 2. The switched on/off state of a sensor is only used as a term for identifying insertion of a pen, and does not always indicate that the first sensor 131 and the second sensor 132 are switched off when the pen is inserted. If the pen 210 is removed, the first sensor 131 firstly changes from a switched-off state to a switched-on state, and the second sensor 132 may also change from a switched state to a switched-on state.

Specifically, if both the first sensor 131 and the second sensor 132 are in a switched-on state, the control unit 110 of the electronic device 100 determines that the pen 210 is removed. According to the present invention, the control unit 110 sets an elapsed time between the time of the first sensor 131 changing from a switched-off state to a switched-on state and the time of the second sensor 132 changing from a switched-off state to a switched-on state as a time required for removing the pen 210 from the electronic device 100. Alternatively, the control unit 110 sets the elapsed time between the time of the first sensor 131 changed from a switched-off state to a switched-on state and the time of the pen 210 touching the display unit of the EMR panel 121 of the electronic device 100 as the time required for removing the pen 210. Alternatively, the control unit 110 sets the elapsed time between the time of the second sensor 132 changed from a switched-off state to a switched-on state and the time of the pen 210 touching the display unit of the EMR panel 121 of the electronic device 100 as the time required for removing the pen 210. The first sensor 131 and the second sensor 132 may be configured with a Hall sensor or an EMR sensor as well as the switch sensor. The electronic device 100 according to the present invention compares the time required for removing the pen 210 with a critical value stored in the memory 140, and executes a corresponding function stored in the memory 140 according to the comparing result.

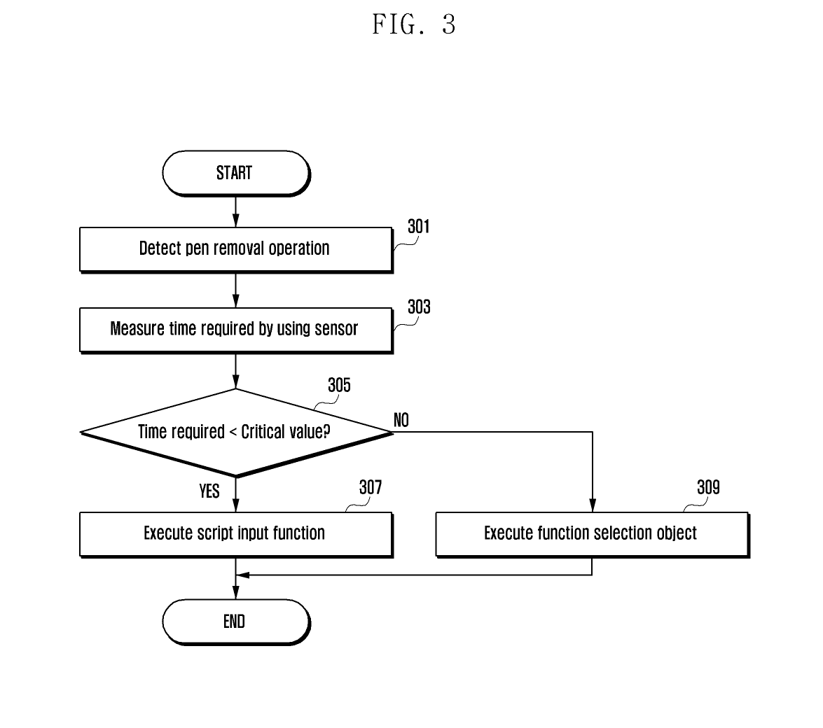

FIG. 3 illustrates a method for executing a function corresponding to a time required for removing a pen according to various embodiments of the present invention.

Referring to FIG. 3, the control unit 110 detects removal of a pen by using the first sensor 131 and the second sensor 132 of the sensor unit 130 at step 301. The control unit 110 detects the operation of removing a pen based on at least one of an electric signal generated when a physical pressing force of the pen is released, an electromagnetic resonant signal generated by a coil installed in the pen, and a magnetic field signal generated by a magnet installed in the pen. The pen is inserted in the electronic device 100, and the control unit 110 determines that the pen is inserted if both the first sensor 131 and the second sensor 132 of the sensor unit 130 are in a switched-off (i.e., inactive) state.

The control unit 110 determines that the pen is removed from the electronic device 100 based on the time taken for the first sensor 131 and the second sensor 132 to change from an inactive state to an active state. The time of the first sensor 131 and the second sensor 132 changing from an inactive state to an active state may be defined as the time taken to detect an inactivity release signal. The control unit 110 measures the time required by using the first sensor 131 and second sensor 132 at step 303.

The “time required” indicates the time required for removing a pen from the electronic device 100. For example, an elapsed time between a first time of the first sensor 131 installed in the electronic device 100 changing from an inactive state to an active state and a second time of the second sensor 132 changing from an inactive state to an active state defines a first required time. If both the first sensor 131 and the second sensor 132 are in an active state, the control unit 110 determines that the pen is removed from the electronic device 100.

An elapsed time between the first time, which is the time of the first sensor 131 changing from an inactive state to an active state, or the second time, which is the time of the second sensor 132 changing from an inactive state to an active state, and the time of detecting a pen touch input in the display unit 130 of the electronic device 100 may be defined as a second required time. Specifically, if the first sensor 131 or the second sensor 132 is in an active state and the pen touches the display unit 130, the control unit 110 determines that the pen is removed from the electronic device 100.

The control unit 110 measures the first time required or the second time required by using the first sensor 131 and the second sensor 132 at step 303. The control unit 110 determines whether the measured time required is less than a critical value pre-stored in the memory 140 at step 305. The critical value is a numeric value predetermined by a developer or a user so that a specific function of the electronic device 100 is executed based on the measured required time. If the time required is less than the critical value at step 305, the control unit 110 executes a script input function at step 307. The time required being less than the critical value indicates that a user urgently removed the pen from the electronic device 100. The control unit 110 determines that the user removed the pen to urgently record a specific content, and executes a script input function so that the user can immediately record the specific content. The script input function is an application such as a notepad for recording the specific content. However, the present invention is not limited to this script input function, and other script input functions stored in the electronic device 100 can be executed.

If the time required is equal to or greater than the critical value at step 305, the control unit 110 executes a function selection object at step 309. The time required being greater than the critical value indicates that a user did not urgently remove the pen from the electronic device 100. That is, the control unit 110 determines that a specific content does not need to be urgently recorded, and executes a function selection object stored in the memory 140. The function selection object may be a menu window including a specific application related to the pen, which the control unit 110 displays through the executed function selection object. The specific application may be predetermined by a developer, and may be changed or deleted by a user.

The electronic device 100 according to the present invention executes a function corresponding to the time required for removing a pen, determines a user's intention based on the time required for removing the pen, and provides a function according to the user's intention. For example, if the time required for removing a pen from the electronic device 100 is less than a predetermined critical value, the electronic device 100 determines a user's intention of urgently recording a specific content, and executes a script input function. The user can change the script input function so that a function other than the script input function can be executed.

If the time required for removing a pen from the electronic device 100 is greater than the predetermined critical value, the electronic device 100 provides a user interface such as a function selection object including functions available for the pen. The functions provided by the electronic device 100 are preset by a developer of the electronic device 100 or differently set by a user. Accordingly, the electronic device 100 provides a function related to the pen according to a user's intention, and thereby improves user convenience.

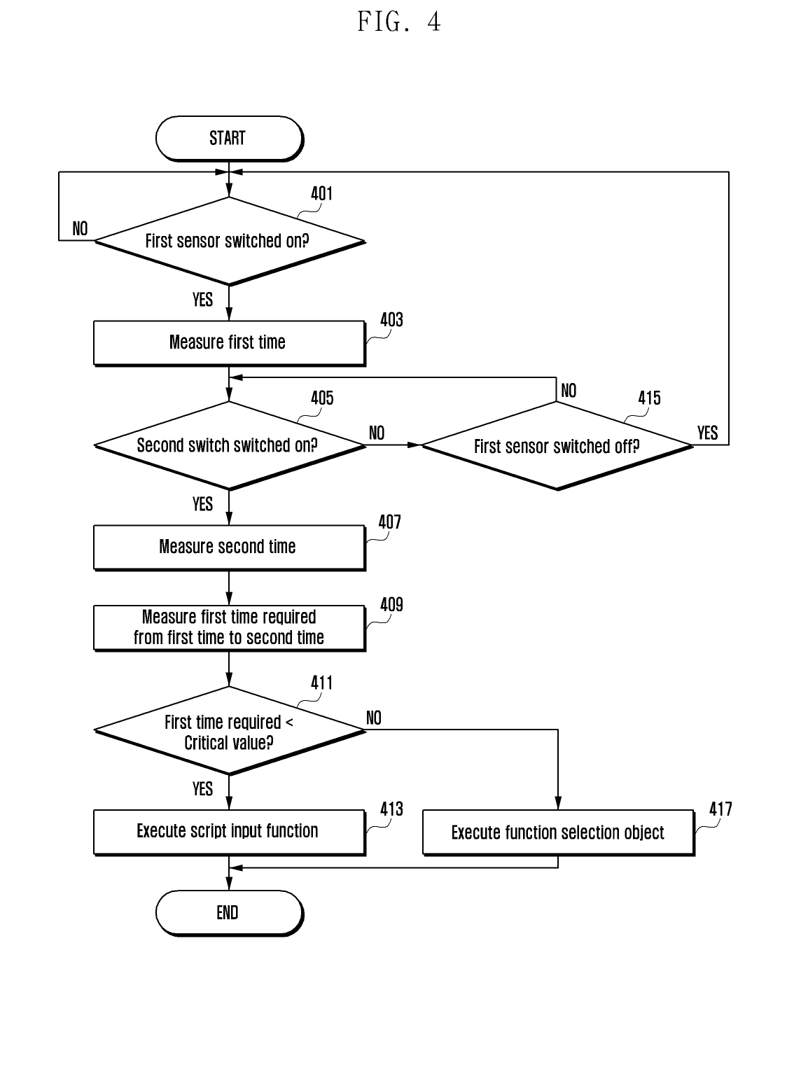

FIG. 4 illustrates a method for executing a function corresponding to a time required for removing a pen according to an embodiment of the present invention. Referring to FIG. 4, a pen is inserted into the electronic device 100 and both the first sensor 131 and the second sensor 132 are in a switched-off state. The control unit 110 determines whether the first sensor 131 is in a switched-on state at step 401. If first sensor 131 is in the switched-on state at step 401, the control unit 110 measures a first time at step 403. The first time is the time required for the first sensor 131 to change from the switched-off state to the switched-on state. The control unit 110 then determines whether the second sensor 132 is in the switched-on state at step 405. If the second sensor 132 is in the switched-on state at step 405, the control unit 110 measures a second time at step 407. The second time is the time required for the second sensor 132 to change from the switched-off state to the switched-on state.

The control unit 110 measures a first time required from the first time to the second time at step 409. The control unit 110 then determines whether the first time required from the first time to the second time is less than a critical value stored in the memory 140 at step 411. The control unit 110 compares the first time required with the critical value by setting the first time required from the first time to the second time as ‘time required for removing a pen’. If the first time required from the first time to the second time is less than the critical value at step 411, the control unit 110 executes a script input function stored in the memory 140 at step 413, and if the first time required from the first time to the second time is equal to or greater than the critical value, the control unit 110 executes a function selection object with which some functions can be selected from a plurality of functions stored in the memory 140 at step 417.

The script input function is a specific application that records specific contents with a pen, and the function selection object displays some functions selected from a plurality of functions related to the pen. The script input function and the function selection object are preset by a developer of the electronic device 100 or set directly by a user. The script input function and the function selection object are set by changing to a specific function or application according to a user's choice. If the second sensor 132 maintains a switched-off state at step 405, the control unit 110 determines whether the first sensor 131 changed from the switched-on state to the switched-off state at step 415.

The second sensor 132 maintaining the switched-off state at step 405 indicates that the pen is not completely removed. Specifically, a user may have temporarily stopped removing of the pen. If the first sensor 131 changes from the switched-on state to the switched-off state at step 415, the control unit 110 returns to step 401. The first sensor 131 changing from the switched-on state to the switched-off state may be interpreted as the pen being re-inserted into the electronic device 100 during the removal process. If the first sensor 131 maintains the switched-on state at step 415, the control unit 110 returns to step 405, and determines whether the second sensor 132 changed from the switched-off state to the switched-on state.

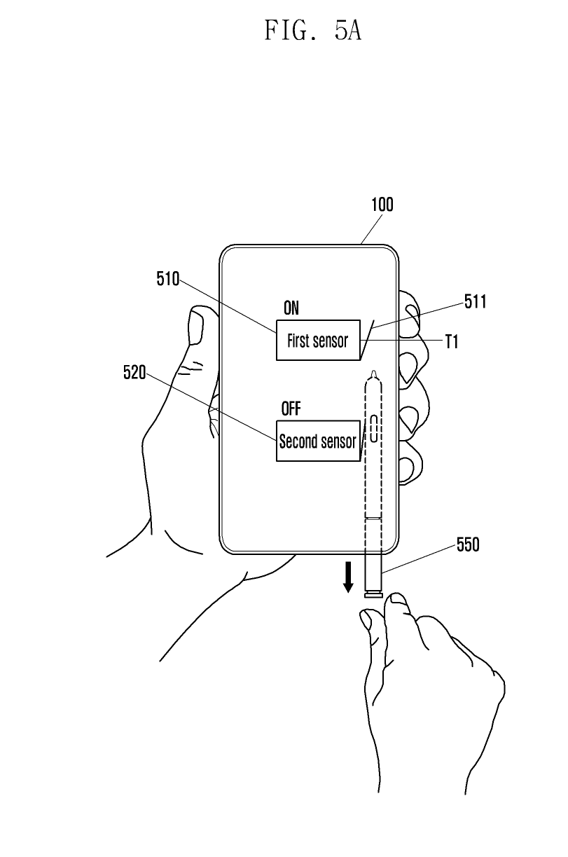

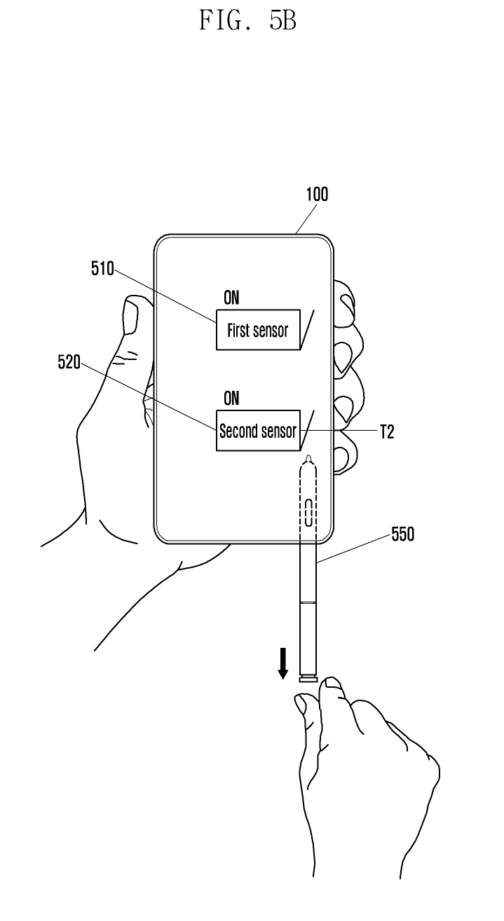

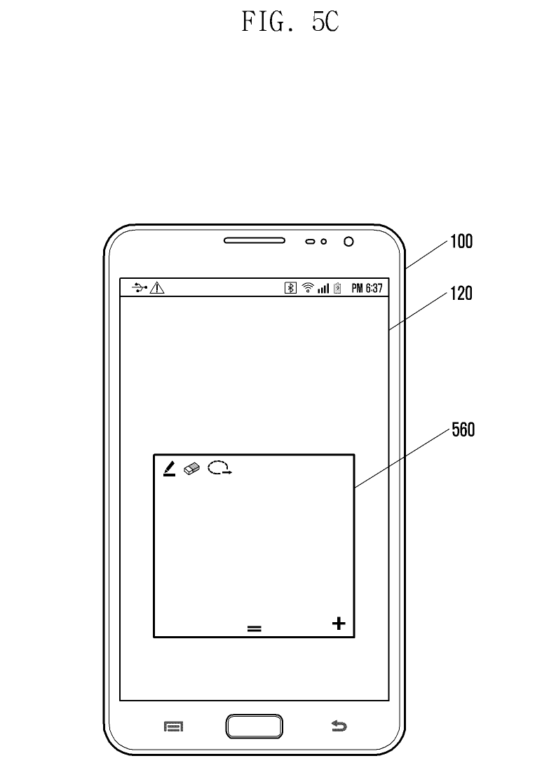

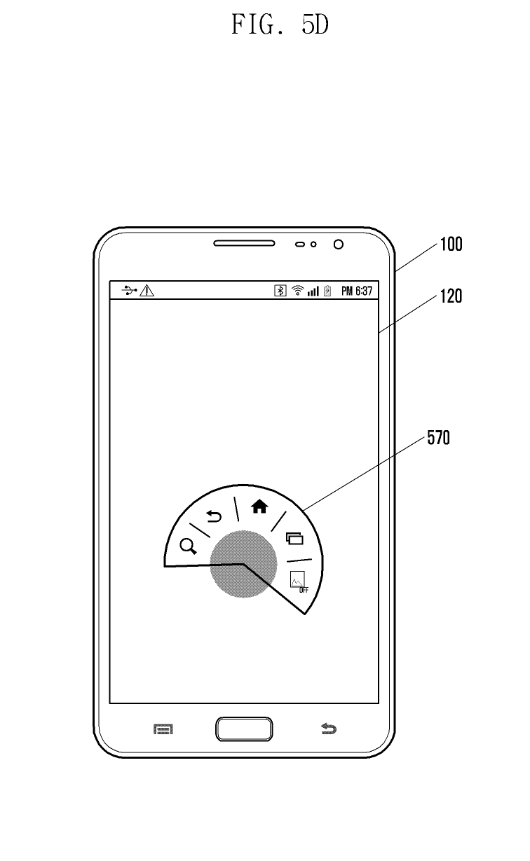

FIGS. 5A, 5B, 5C and 5D illustrate a method for executing a function according to an embodiment of the present invention.

Referring to FIG. 5A, according to a user operation of removing a pen 550, the control unit 110 of the electronic device 100 determines whether a first sensor 510 has changed from a switched-off state to a switched-on state. The first sensor 510 is in the switched-on state of which a switch 511 is released. The control unit 110 then measures a first time T1 when the first sensor 510 changed from the switched-off state to the switched-on state. The second sensor 520 maintains the switched-off state because the pen 550 is not completely removed.

Referring to FIG. 5B, the control unit 110 determines whether the second sensor 520 has changed from the switched-off state to the switched-on state. Subsequently, the control unit 110 measures a second time T2 when the second sensor 520 changed from the switched-off state to the switched-on state. The control unit 110 determines a difference between the first time T1 and second time T2 as the time required for removing the pen 550, compares the first time required from the first time T1 to the second time T2 with a predetermined critical value, and executes a function related to the pen 550 according to the comparison result. The predetermined critical value is set by a developer of the electronic device 100 or set directly by a user. For example, similar to the manner in which a user sets a click speed of a mouse, the electronic device 100 provides a setting screen so that the user can directly set the critical value.

Referring to FIG. 5C, the control unit 110 executes a speed note function 560 if the first time required from the first time T1 to the second time T2 is less than the critical value. The speed note function 560 function corresponds to the ‘script input function’ described in FIG. 3. For example, if the first time required from the first time T1 to the second time T2 is less than the critical value, the control unit 110 of the electronic device 100 outputs the speed note 560 in the display unit 120 of the electronic device 100. The first time required being less than the critical value indicates that a user urgently desires to prepare a memo, and the control unit 110 outputs the speed note 560 according to the user's intention.

The user can immediately prepare a memo by removing the pen without selecting a pen-related function through a user interface. Accordingly, the user can quickly and conveniently use a desired specific function corresponding to the time required for removing the pen. The user can preset a specific function or application to execute according to the time required for removing the pen. The control unit 110 can execute a specific function or application other than the speed note 560 according to a user setting.

Referring to FIG. 5D, the control unit 110 provides a function selection interface 570 so that a specific function or application can be directly selected, if the first time required from the first time T1 to the second time T2 is greater than the critical value. The function selection interface 570 corresponds to the ‘function selection object’ described in FIG. 3. The control unit 110 outputs the function selection interface 570 so that some functions can be selected from a plurality of pen-related functions through the display unit 120. For example, the function selection interface 570 includes a specific menu window with which a scrap-related application, note-related application, and search-related application can be immediately executed.

The first time required being greater than the critical value indicates that a user desires to select a specific function related to the pen, and the control unit 110 provides the function selection interface 570 according to the user's intention. The control unit 110 detects a pen input corresponding to the provided function selection interface 570, and executes a specific function based on the detected pen input.

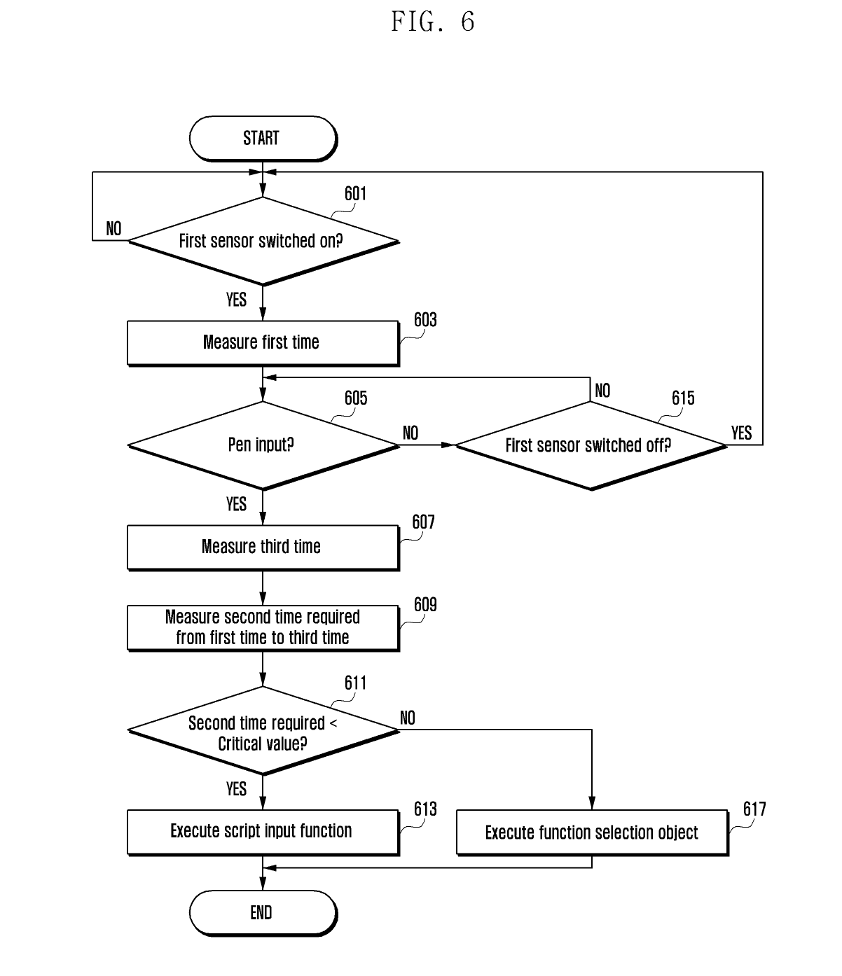

FIG. 6 illustrates a method for executing a function corresponding to a time required for removing a pen according to another embodiment of the present invention. FIG. 6 is similar to FIG. 4, but is different in terms of measuring the time required for removing the pen.

Referring to FIG. 6, the pen is inserted into the electronic device 100, and the first sensor 131 is in a switched-off state. The control unit 110 determines whether the first sensor 131 is in a switched-on state at step 601. If the first sensor 131 is in the switched-on state at step 601, the control unit 110 measures a first time at step 603. The first time is measured when the first sensor 131 changes from the switched-off state to the switched-on state. The control unit 110 determines whether a pen input through the EMR panel 121 of the electronic device 100 has occurred at step 605. The determination of the pen input is performed when an electromagnetic resonant signal or a touch input is detected according to an approach of the pen. If a pen input is generated in the EMR panel 121 at step 605, the control unit 110 measures a third time at step 607. The third time is measured when the control unit 110 of the electronic device 100 detects a pen input through the EMR panel 121. The electronic device 100 shown in FIG. 6 may operate with only the first sensor 131 or the second sensor 132, and the EMR panel 121 may perform the function of another sensor.

The control unit 110 calculates a second time required from the first time to the third time at step 609, and determines whether the second time required from the first time to the third time is greater than a critical value stored in the memory 140 at step 611. The control unit 110 compares the second time required with the critical value by setting the second time required from the first time to the third time as ‘time required for removing a pen’. If the second time required from the first time to the second time is less than the critical value at step 611, the control unit 110 executes a script input function stored in the memory 140 at step 613, and if the second time required from the first time to the second time is equal to or greater than the critical value, the control unit 110 executes a function selection object stored in the memory 140 at step 617.

The script input function and the function selection object are preset by a developer of the electronic device 100 or set directly by a user, and are set with a specific function according to a user's choice. If a pen input is not detected through the EMR panel 121 at step 605, the control unit 110 determines whether the first sensor 131 has changed from the switched-on state to the switched-off state at step 615. If the first sensor 131 changed from the switched-on state to the switched-off state at step 615, the control unit 110 returns to step 601. If the first sensor 131 maintains the switched-on state at step 615, the control unit 110 returns to step 605 and determines whether a pen input has occurred. If the first sensor 131 maintains the switched-on state for a predetermined time at step 615, the control unit 110 informs the user that the pen has been removed from the electronic device 100 by outputting an alarm sound. However, the present invention is not limited thereto. For example, the control unit 110 can inform the user that the pen is removed by using a vibration, blinking, or lighting in addition to or instead of the alarm sound.

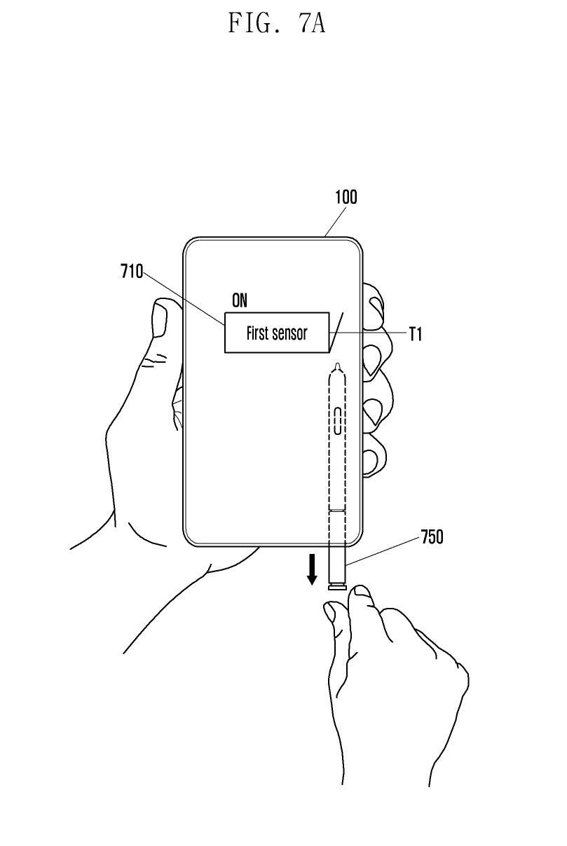

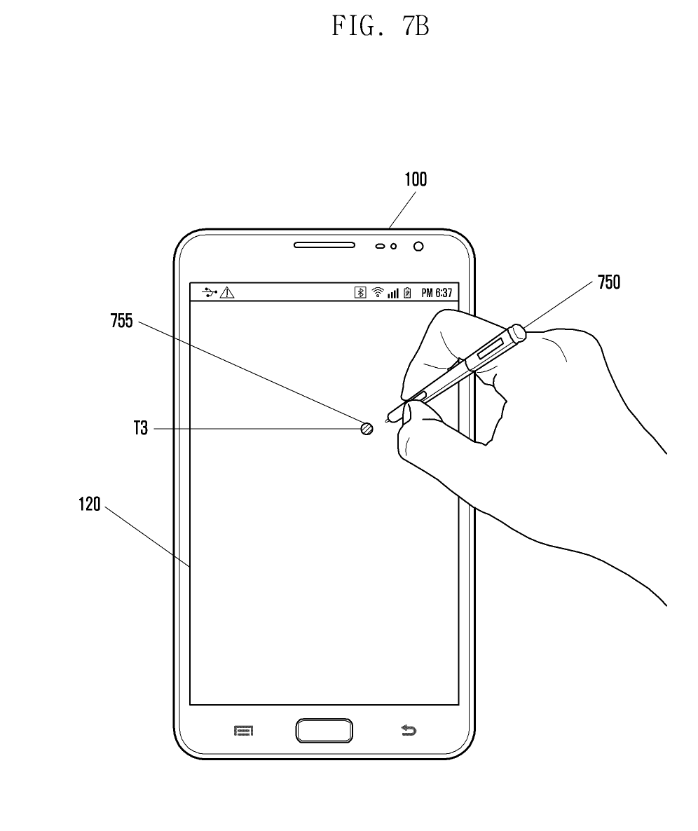

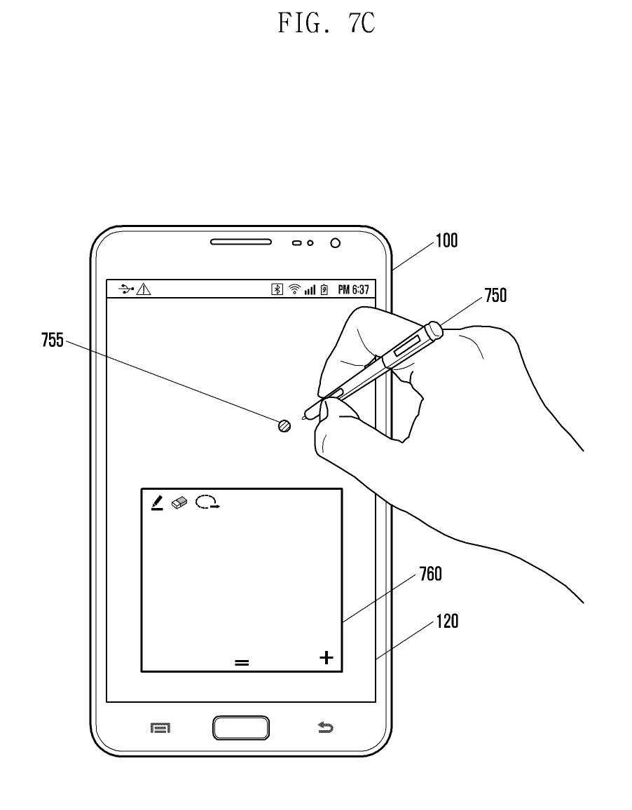

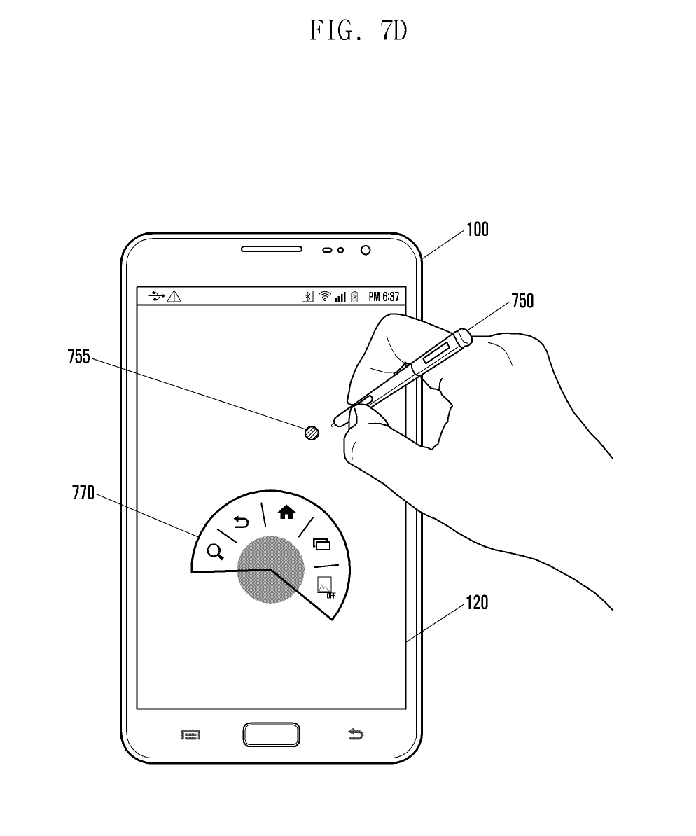

FIGS. 7A, 7B, 7C and 7D illustrate the method for executing a function described in FIG. 6.

Referring to FIG. 7A, according to a user operation of removing a pen 750, the control unit 110 of the electronic device 100 determines whether the first sensor 710 has changed from a switched-off state to a switched-on state. The control unit 110 measures a time when the first sensor 710 changed from the switched-off state to the switched-on state as a first time T1. According to another embodiment of the present invention, the electronic device 100 includes at least one sensor.

Referring to FIG. 7B, the control unit 110 detects an input 755 according to an approach of the pen 750 to the touch panel 122 of the display unit 120. If the input 755 of the pen 750 is detected from the display unit 120, the control unit 110 measures the time of detecting the input 755 as a third time T3. The control unit 110 measures an elapsed time from the first time T1 to the third time T3 as a second time required, which is defined as the time required for removing the pen 750 from the electronic device 100. Subsequently, the control unit 110 compares the second time required from the first time T1 to the third time T3 with a critical value stored in the memory 140, and executes a function related to the pen 750 according to the comparing result.

Referring to FIG. 7C, if the second time required from the first time T1 to the third time T3 is less than the critical value stored in the memory 140, the control unit 110 executes a speed note function 760. The second time required from the first time T1 to the third time T3 being less than the critical value stored in the memory 140 indicates that a user has a note or memo to be urgently prepared. Therefore, the control unit 110 executes a predetermined speed note function 760 according to the user's intention. The control unit 110 provides an output to the display unit 120 by executing the speed note function 760, which is predetermined by a developer or a user of the electronic device 100. The control unit 110 can execute another function stored in the memory 140 as well as the speed note function 760 according to a user setting.

Referring to FIG. 7D, the control unit 110 provides a function selection object 770 if the second time required from the first time T1 to the third time T3 is greater than the critical value stored in the memory 140. The function selection object 770 is a menu selection window for directly selecting a specific function or application such as a shortcut function in a computer. The second time required from the first time T1 to the third time T3 being greater than the critical value stored in the memory 140 indicates that a user has no note or memo to be urgently prepared. Accordingly, the control unit 110 provides the function selection object 770 so that the user can select a specific function or application, which is set according to a user's intention.

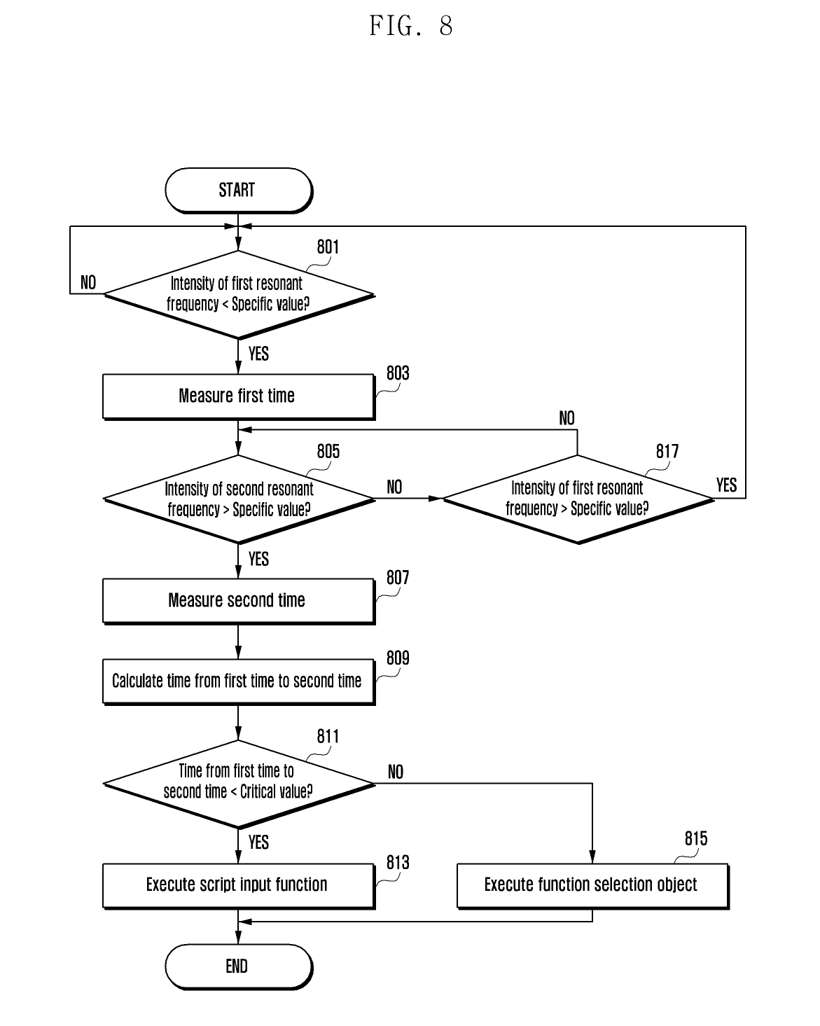

FIG. 8 illustrates a method for executing a function corresponding to a time required for removing a pen according to an embodiment of the present invention.

Referring to FIG. 8, the control unit 110 determines that a pen is inserted into the electronic device 100 by using an EMR sensor which detects a resonant frequency of a coil installed in the pen. The control unit 110 detecting a first resonant frequency indicates that the control unit 110 detects a first resonant frequency having an intensity that is greater than a predetermined value. The predetermined value is a specific value preset by a developer or a user of the electronic device 100. The electronic device 100 integrates at least one EMR sensor, and measures a time required for removing the pen by using the EMR sensor.

For example, at least 2 coils are installed in the pen, and each coil has a different coil winding number which generates a resonant frequency. The coils emitting different resonant frequencies are installed, respectively in the upper and lower parts of the pen. The coil installed in a footer or bottom portion of the pen is a first coil emitting a first resonant frequency, and the coil installed in a header or top portion of the pen is a second coil emitting a second resonant frequency. A first detection sensor is installed corresponding to the location of the first coil installed in the header of the pen and a second detection sensor is installed corresponding to the location of the second coil installed in the footer of the pen when the pen is inserted in the electronic device 100.

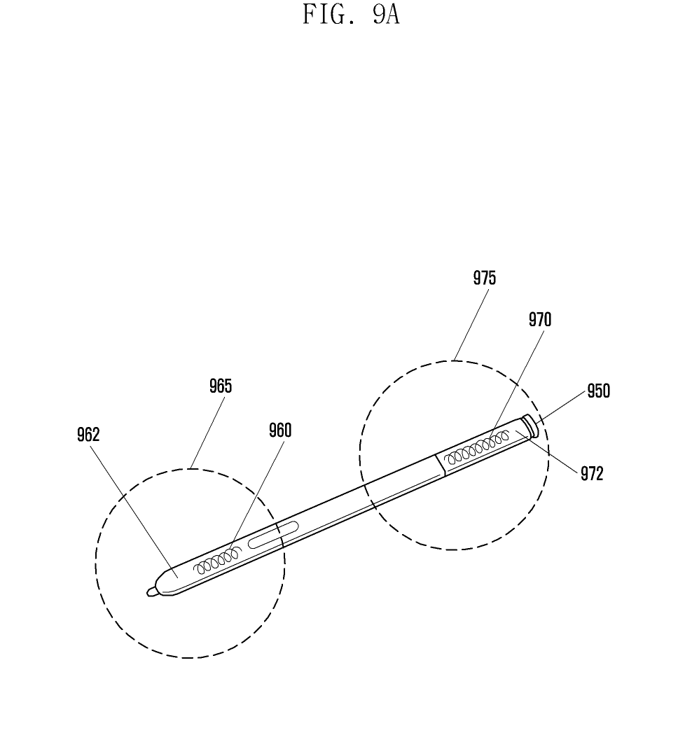

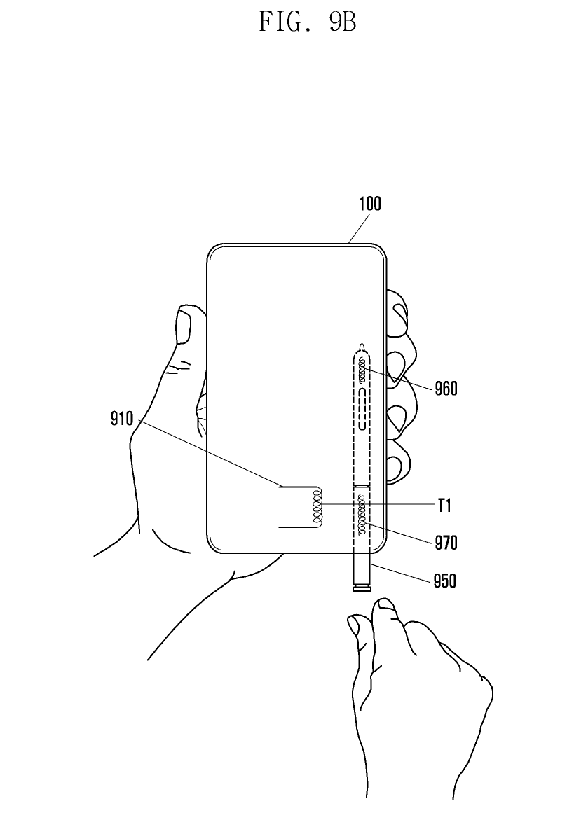

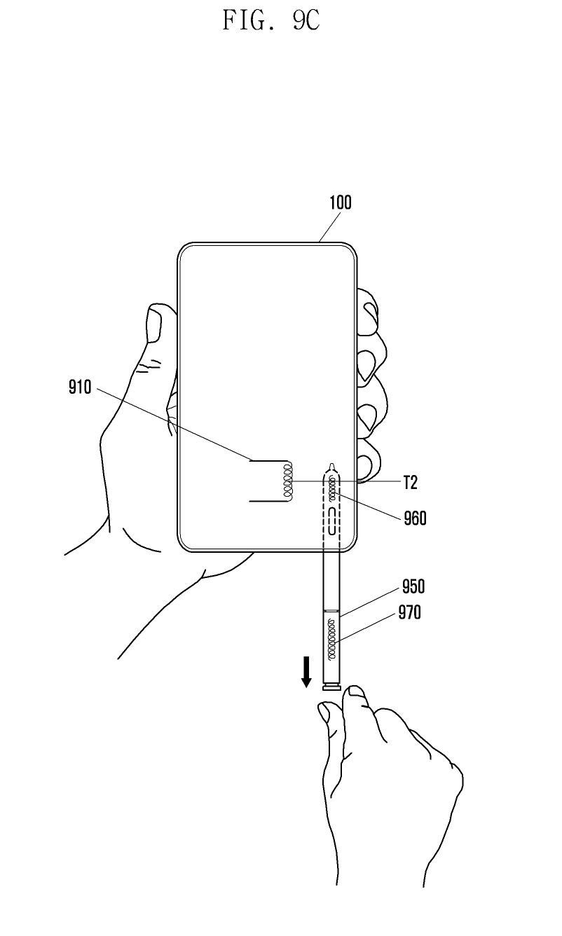

FIGS. 9A and 9B which will be discussed below, illustrate when one sensor is installed in the electronic device 100, but the present invention is not limited thereto.

The control unit 110 determines whether the intensity of the first resonant frequency is less than a specific value at step 801. If the intensity of the first resonant frequency is less than the specific value at step 801, the control unit 110 measures a first time at step 803. The intensity of the first resonant frequency being less than the specific value indicates that the pen is removed from the electronic device 100. Subsequently, the control unit 110 determines whether the intensity of the second resonant frequency is greater than a specific value at step 805. The specific values steps 801 and 805 may be identical, however the present invention is not limited thereto. That is, the specific values may be different numeric values corresponding to the first coil and the second coil installed in the pen.

The control unit 110 determines reception of the second resonant frequency if the intensity of the received second resonant frequency is greater than a specific value. If the intensity of the second resonant frequency is greater than the specific value at step 805, the control unit 110 measures a second time at step 807, and calculates an elapsed time from the first time to the second time at step 809. The electronic device 100 defines the elapsed time from the first time to the second time as the ‘time required for removing a pen’. The control unit 110 determines whether the elapsed time from the first time to the second time is less than a critical value stored in the memory 140 at step 811. The control unit 110 compares the elapsed time from the first time to the second time with a critical value pre-stored in the memory 140. If the elapsed time from the first time to the second time is less than the critical value at step 811, the control unit 110 executes a script input function stored in the memory 140 at step 813, and if the elapsed time from the first time to the second time is equal to or greater than the critical value, the control unit 110 executes a function selection object stored in the memory 140 at step 815.

The script input function and the function selection object can be changed to a specific function stored in the electronic device 100 according to a user setting. If the intensity of the second resonant frequency is equal to or less than the specific value at step 805, the control unit 110 determines whether the intensity of the first resonant frequency is greater than a specific value at step 817. The intensity of the second resonant frequency being greater than a specific value indicates that the user has not yet removed the pen from the electronic device 100. For example, the user may temporarily stop removal of the pen from the electronic device 100.

If the intensity of the first resonant frequency is greater than the specific value at step 817, the control unit 110 determines that the user re-inserted the pen, and returns to step 801. If the intensity of the first resonant frequency is equal to or less than the specific value at step 817, the control unit 110 returns to step 805 and determines whether the intensity of the second resonant frequency is greater than a specific value.

FIGS. 9A, 9B, and 9C illustrate the method for executing a function described in FIG. 8.

FIG. 9A illustrates locations of a first coil 970 and second coil 960 installed in a pen 950. Referring to FIG. 9A, the pen 950 integrates coils emitting different resonant frequencies, respectively in the header 972 and the footer 962 of the pen 950. In FIG. 9A, the footer 962 of the pen 950 includes the pen tip.

For example, a first coil 970 is installed in the header 972 of the pen 950 and a second coil 960 is installed in the footer 962 of the pen 950. The first coil 970 emits a first resonant frequency 975 and the second coil 960 emits a second resonant frequency 965. The first coil 970 and the second coil 960 have different winding numbers and emit different resonant frequencies. Although the winding number of the first coil 970 is greater than that of the second coil 960 in FIG. 9A, the present invention is not limited thereto, and winding intervals and winding cross sections of the first coil 970 and the second coil 960 may be differently configured.

FIG. 9B illustrates a moment of removing the pen 950. If the pen 950 is completely inserted in the electronic device 100, the control unit 110 of the electronic device 100 is in a state of receiving the first resonant frequency emitted from the first coil 970 through the sensor 910. The state of receiving the first resonant frequency indicates that the control unit 110 receives the first resonant frequency greater than a specific value through the sensor 910. Although only one sensor 910 is shown in FIG. 9B, the present invention is not limited thereto, and the electronic device 100 can also determine insertion of the pen 950 by installing at least 2 sensors.

The sensor 910 is an EMR sensor and receives resonant frequencies, respectively emitted by the first coil 970 and the second coil 960 integrated in the pen 950. Referring to FIG. 9B, according to a user's operation of removing the pen 950, the control unit 110 of the electronic device 100 determines that the intensity of the first resonant frequency received through the sensor 910 is decreasing below a specific value. The control unit 110 measures a first time T1 when the intensity of the first resonant frequency decreases below the specific value, which is a numeric value predetermined by a developer or a user. Although the sensor 910 is located corresponding to the header of the pen 950 in FIG. 9B, the present invention is not limited thereto.

Referring to FIG. 9C, the control unit 110 of the electronic device 100 receives a second resonant frequency emitted by the second coil 960 through the sensor 910. Receiving the second resonant frequency indicates that the control unit 110 receives a second resonant frequency greater than a specific value through the sensor 910. The control unit 110 measures a second time T2 when the intensity of the second resonant frequency greater than the specific value is received through the sensor 910. The changing of the resonant frequency being received through the sensor 910 from the first resonant frequency to the second resonant frequency indicates that the pen 950 is removed from the electronic device 100.

The control unit 110 calculates an elapsed time from the first time T1 to the second time T2, and defines the elapsed time as the ‘time required for removing a pen’. Subsequently, the control unit 110 determines whether the elapsed time from the first time T1 to the second time T2 is greater than a critical value stored in the memory 140. The critical value disclosed in various embodiments of the present invention is a specific numeric value that is compared with the ‘time required from removing a pen’, and is configured with a plurality of numeric values corresponding to a timing of measuring the ‘time required for removing a pen’. If the difference between the first time T1 and the second time T2 is less than the critical value, the control unit 110 executes a script input function stored in the memory 140, and if the difference between the first time T1 and the second time T2 is equal to or greater than the critical value, the control unit 110 executes a function selection object stored in the memory 140.

According to various embodiments of the present invention, the devices or methods may be implemented by computer program instructions stored in a non-transitory computer-readable storage medium. When the instructions are executed by at least one processor (e.g. processor 120), the at least one processor executes the functions corresponding to the instructions. The computer-readable storage medium may be the memory 130. At least a part of the programming module may be implemented by the processor 120. At least a part of the programming module may include modules, programs, routines, sets of instructions, and processes for executing the at least one function.

The computer-readable storage medium includes magnetic media such as a floppy disk and a magnetic tape, optical media including a compact disc (CD) ROM and a digital video disc (DVD) ROM, a magneto-optical media such as a floptical disk, and the hardware device designed for storing and executing program commands such as ROM, RAM, and flash memory. The programs commands include the language code executable by computers using the interpreter as well as the machine language codes created by a compiler. The aforementioned hardware device can be implemented with one or more software modules for executing the operations of the various embodiments of the present invention.

The module or programming module of the present invention may include at least one of the aforementioned components with omission of some components or addition of other components. The operations of the modules, programming modules, or other components may be executed in series, in parallel, recursively, or heuristically. Some operations may be executed in a different order, omitted, or extended with other operations.

The method and the electronic device according to various embodiments of the present invention measures a time required for removing an electronic pen by using a sensor when the electronic pen inserted in the electronic device is removed from the electronic device. The electronic device performs a predetermined function such as a speed note function, function selection interface, and application, according to the time required for removing an electronic pen. The electronic device determines a user's intention and executes an application corresponding to the user's intention in the process of removing the electronic pen. The method and the electronic device according to various embodiments of the present invention improves user conveniences by reducing the time required for selecting and executing a desired application when a user desires to use an application related to the electronic pen.

Although various embodiments of the present invention have been described using specific terms, the specification and drawings are to be regarded in an illustrative rather than a restrictive sense in order to assist in the understanding of the present invention. It is obvious to those skilled in the art that various modifications and changes can be made thereto without departing from the broader spirit and scope of the disclosure.

Although the present invention has been described above using specific terms in connection with the certain embodiments disclosed in the specification and drawings, it will be understood by those skilled in the art that various changes in form and details may be made therein without departing from the scope of the present invention. Therefore, the scope of the present invention should not be defined as being limited to the embodiments, but should be defined by the appended claims and equivalents thereof.

What is claimed is:

1. A method for executing a function in an electronic device, the method comprising:
detecting a removal of an electronic pen from the electronic device by using a plurality of detection sensors;
determining a time interval based on a first time of an inactivity release signal detected by a first detection sensor among the plurality of detection sensors, or a second time of the inactivity release signal detected by a second detection sensor among the plurality of detection sensors corresponding to the removal of the electronic pen; and
executing at least one function related to a script input using the electronic pen if the time interval is less than a critical value.

2. The method of claim 1, wherein determining the time interval comprises:
determining a first time required from the first time to the second time as the time interval.

3. The method of claim 1, further comprising:
determining a second time required, between the first or second time, to a third time as the time interval, corresponding to the third time of detecting an electromagnetic resonant signal or a touch input according to an approach of the electronic pen toward a display unit electrically connected with the electronic device.

4. The method of claim 1, wherein detecting the removal of the electronic pen comprises:
detecting the removal of the electronic pen through a first detection sensor installed adjacent to a footer of the electronic pen where a pen tip is located and a second detection sensor installed adjacent to a header of the electronic pen when the electronic pen is inserted into the electronic device.

5. The method of claim 4, wherein determining the time interval comprises:
determining a third time required, between a time of detecting a first electromagnetic resonant signal having a first resonant frequency band through the second detection sensor, and a time of detecting a second electromagnetic resonant signal having a second resonant frequency band as the time interval, if the electronic pen includes coils having different resonant frequency bands for the header and footer, respectively.

6. The method of claim 1, wherein determining the time interval comprises:
detecting, as the inactivity release signal, at least one of an electric signal generated when a physical pressing force of the electronic pen is released through the plurality of detection sensors, an electromagnetic resonant signal generated by a coil of the electronic pen, and a magnetic field signal generated by a magnet installed in the electronic pen.

7. The method of claim 1, further comprising:
providing a selection object for selecting at least one of a variety of functions related to the electronic pen through the display unit, if the time interval is greater than the critical value.

8. An electronic device comprising:
a sensor unit configured to include a plurality of detection sensors and to measure a time interval required for removing an electronic pen from the electronic device based on the plurality of detection sensors; and
a control unit configured to detect removal of the electronic pen from the electronic device through the sensor unit, to determine a time interval based on a first time of an inactivity release signal detected by a first detection sensor among the plurality of detection sensors, or a second time of an inactivity release signal detected by a second detection sensor among the plurality of detection sensors corresponding to the removal of the electronic pen from the electronic device, and to execute at least one function related to a script input using the electronic pen if the time interval is less than a critical value.

9. The electronic device of claim 8, wherein the control unit is further configured to determine a first time required from the first time to the second time as the time interval.

10. The electronic device of claim 8, wherein the control unit is further configured to determine a second time required, between the first time or second time, to a third time as the time interval, corresponding to the third time of detecting an electromagnetic resonant signal or a touch input according to an approach of the electronic pen toward a display unit electrically connected with the electronic device.

11. The electronic device of claim 8, wherein the control unit is configured to detect the removal of the electronic pen through a first detection sensor installed adjacent to a footer of the electronic pen where a pen tip is located and a second detection sensor installed adjacent to a header of the electronic pen when the electronic pen is inserted into the electronic device.

12. The electronic device of claim 11, wherein the control unit is further configured to determine, as the time interval, a third time required, between a time of detecting a first electromagnetic resonant signal having a first resonant frequency band through the second detection sensor, and a time of detecting a second electromagnetic resonant signal having a second resonant frequency band, if the electronic pen includes coils having different resonant frequency bands for the header and footer, respectively.

13. The electronic device of claim 8, wherein the control unit is further configured to detect, as the inactivity release signal, at least one of an electric signal generated when a physical pressing force of the electronic pen is released through the plurality of detection sensors, an electromagnetic resonant signal generated by a coil of the electronic pen, and a magnetic field signal generated by a magnet installed in the electronic pen.

14. The electronic device of claim 8, wherein the control unit is further configured to provide a selection object for selecting at least one of a variety of functions related to the electronic pen through the display unit, if the time interval is greater than the critical value.
